(19) United States
(12) Patent Application Publication
(10) Pub. No.: US 2006/0232396 A1
(43) Pub. Date: Oct. 19, 2006

(54) Brake warning system for a motor vehicle

(76) Inventor: Sadeg Ahmed Oasem, Adan (KW)

Correspondence Address: LOWE HAUPTMAN BERNER, LLP, 1700 DIAGONAL ROAD, SUITE 300, ALEXANDRIA, VA, 22314, US

(21) Appl. No.: 11/402,911

(22) Filed: Apr. 13, 2006

Related U.S. Application Data
(60) Provisional application No. 60/671,096, filed on Apr. 14, 2005.

(51) Int. Cl. B60Q 1/44

(52) U.S. Cl. 340/479; 340/467

(57) ABSTRACT

A progressive break light warning system for a motor vehicle includes a variable brightness brake light in which the brightness of the light increases and decreases with changes in voltage. An electrical circuit and pressure sensor senses the pressure applied to the brake pedal and increases the voltage output as the pressure is increased. The system also flashes the brake lights on and off when the pressure on the brake pedal exceeds a pre-selected level.

### FIELD OF THE INVENTION

This invention relates to a brake warning system for a motor vehicle and more particularly to a brake warning system wherein the intensity of one or more brake lights are increased as the pressure on the brake pedal increases.

### BACKGROUND FOR THE INVENTION

As traffic in metropolitan and surrounding areas increases, there is an increased potential for accidents. This problem is exacerbated by an increased demand on individuals time and a degree of impatience due to the increased traffic. In addition, the use of cell phones competes for a driver's attention and contributes to a number of accidents many of which involve one car running into the back of another as it slows or stops for traffic lights, stop signs, to avoid other cars, pedestrians and animals.

There have been a number of approaches to solve this problem. For example, a U.S. Patent of Ishikawa et al., U.S. Pat. No. 5,594,414 discloses a sensor for sensing the extent of accelerator operation and a luminant display placed so as to face the outside of the car. This display is designed to expand according to the extent of accelerator operation. It is also provided with means for sensing the rotation of the engine and the extent of brake pedal operation. The rotation of the engine and the extent of brake pedal operation together with the accelerator operation level are luminancely displayed inside and outside the car. As disclosed therein, the system is also provided with a speed sensing means and an acceleration-deceleration sensing means. A plurality of significantly different character strings is displayed outside the car in response to sensing results of the sensing means.

A more recent patent of Cohen et al., U.S. Pat. No. 6,573,830 discloses a progressive brake light system wherein a brake sensor is arranged to sense the travel of a brake pedal and a brake light display arranged to illuminate or extinguish in sequence or progressively in response to the travel of the brake pedal. A microcontroller is provided for receiving a signal from the brake sensor and controlling the brake light display. The brake sensor is typically an optical sensor utilizing infrared transmitters and receivers arranged to sense the distance and direction of travel of the brake pedal. The brake light display consists of a row of lights of light emitting diodes (LEDs), which are arranged or illuminated from the opposite ends towards the middle as the brake pedal is depressed and to extinguish in reverse sequence when the brake pedal is released.

A still further approach to a progressive slow stop signaling system is disclosed in a U.S. Patent of Elliott, U.S. Pat. No. 6,753,769. As disclosed therein, a progressive slow/stop signaling system for energizing a plurality of yellow and red lamps is mounted on the rear of a vehicle to indicate impending changes in the speed of the vehicle. The lamps are energized in a sequence depending on the positions of the brake and accelerator pedals.

Notwithstanding the above, it is presently believed that there may be a market for an improved progressive brake light warning system in accordance with the present invention. There should be a demand for such systems because they will minimize auto accidents and casualties by giving drivers a simple indication of what is going on in front of them. In essence, the system will allow a driver to estimate the level of braking of the car in front since the harder a person pushes on the brake, the greater the light. In this invention, the intensity of the light will increase until they reach a stop or locking position. At this point the brake lights will flash on and off indicating that the car is stopped and warning a following driver of an emergency stop. Advantageously the system works on a simple LED reader which is simpler and smaller than its analog counterpart and is readily available at reasonable prices. Further an integrated circuit using a logarithmic version wherein each LED operates with a 3 dB difference from the previous one and a jumper is provided to allow a dot or bar mode.

Other advantages of the present invention reside in its low cost small size, simple design, durability and easy installation in an automobile.

### BRIEF SUMMARY OF THE INVENTION

In essence, the present invention contemplates a progressive brake light warning system for a motor vehicle such as an automobile, truck or motorcycle. The system includes a variable brightness brake light in which the brightness of the light increases and decreases with changes in voltage. An electrical circuit means and a pressure sensor for sensing the pressure applied to a brake pedal and increasing the voltage output as the pressure increases is provided. The electrical circuit means also decreases the voltage output as the pressure is decreased. The system also includes means for connecting the voltage output to the brake lamp for increasing the brightness or intensity of the lamp as the pressure of the brake pedal increases. Further, the system includes means for flashing the brake light on and off when the pressure on the brake pedal exceeds the preselected level. In addition, means for sensing forward movement of the auto are provided and together with means for maintaining the flashing of the brake light on and off until the stopped vehicle resumes forward movement stops the flashing of the light as the car begins to move forward.

The invention will now be described in connection with the accompanying drawings wherein like reference numerals have been used to identify like parts.

### DESCRIPTION OF THE DRAWINGS

FIG. 1 is a LED VU meter circuit for use in the present invention;

FIG. 2 is a simple four wave rectifier and preamp circuit for use in the present invention;

FIG. 3 is a simple graphic circuit illustrating the invention;

FIG. 4 is a layout graphic with a printed PCB;

FIG. 5 is another layout graphic;

FIG. 6 is a circuit diagram of a PCB foil pattern of an LED VU meter; and

FIG. 7 is a block diagram illustrating the invention.

### DESCRIPTION OF THE PREFERRED EMBODIMENTS OF THE INVENTION

The main idea of this invention is to minimize as much as possible automobile accidents and death by giving drivers a clear indication of what is going on in front of them. For example, when an individual is driving behind a vehicle he can estimate the level of braking when something ahead happens, for example, the harder an individual presses on the brakes the greater the intensity of the light will be and when the car comes to a stop brake lights will flash indicating that the car is stopping and that there is an emergency condition or a completely stopped vehicle in front of the driver. In this way the light level gives an idea to following drivers how fast the car in front of him is braking. It will contribute to safety on the road, the psychological relief of drivers therefore reducing aggressive driving, provide more confidence in driving and insofar as possible avoid the hazards of an emergency stop.

In this invention, an LED meter is simpler and smaller than its analog counterpart and is readily available from electronic equipment stores. Therefore, in a preferred embodiment of the invention, the system is based on a integrated circuit and uses a logarithmic version, each LED operates with a 3 dB difference from the previous one and a jumper is provided to allow dot or bar mode.

In this embodiment of the invention, an essential part of the expandable analyzer and one meter circuit for each frequency band. As for example, utilizing the many uses for a simple LED VU meter. These meters are ideal as power meters or amplifiers and can be used with mixers including the high quality mixer described hereinafter, preamps and any other application where it is important to know the signal level.

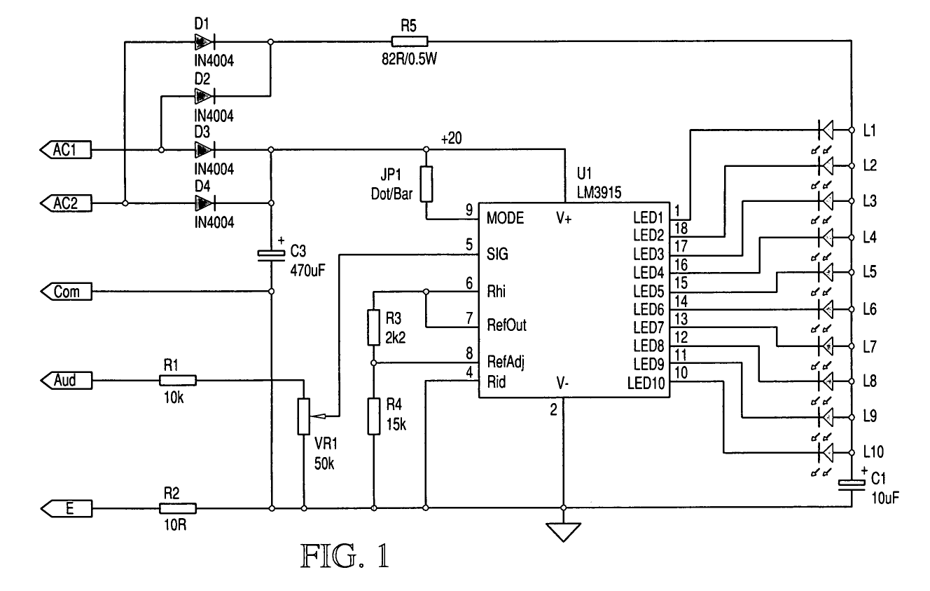

The circuit shown in FIG. 1 uses a single integrated circuit having few discrete components. There are rectifier circuits so that the DC to the LEDs is almost unfiltered this allows a higher LED current with lower dissipation than would be the case if the DC were fully smoothed. Full smoothing would also require a much larger capacitor thus increasing the size and cost of the system which is especially important if it is used for the expandable analyzer, since there will be at least 10 meter circuits needed.

A voltage sensor is placed onto the braking pedal and it raises voltage in accordance with pedal pressing through a variable resistor. Such systems are considered to be very reasonable in cost.

As shown in FIG. 1, L1 to L8 will normally be green (normally operating range) and L9 and L10 red (indicating overload). This gives a 6 dB overload margin when the unit is calibrated as described below. As shown, full scale sensitivity (with VR1 at maximum) is 12 volts peak (approximately 8.5 volts RMS). This is designed for direct connection to the speaker output of an amplifier, but is still suitable for use with preamps if the sensitivity is changed.

JP1 determines dot or bar mode. When the jumper is installed, the unit operates in bar mode meaning that LEDs will light in a continuous bar. If the jumper is omitted, then only the LED corresponding to the current signal level will light. Dot mode uses far less current, but the display is less visible.

Power comes from the car battery or a 15-0-15 transformer. Generally, the smallest one available is used as average power is quite low. The peak current is about 120 mA DC, so a 5VA transformer will be sufficient to power two meter circuits. One 15V winding goes to the terminal AC1, the other goes to AC2 and the center tap is connected to Com (Common). The formally for sensitivity is somewhat complex and is further complicated by the fact that the same resistors that change the reference voltage also affect the LED current. As shown, LED current is about 12 mA. To save calculations, a table to set the reference voltages is provided. This may need to be slightly lower than the voltage to be measured so that the fine adjustments can be made with VR1. LED current is fixed at about 10-13 mA for all voltages.

TABLE 1
Resistor Values For Different Voltages

| Ref. Voltage | R3 (k) | R4 (k) | 1 led (mA) |
|---|---|---|---|
| 12 (11.6) | 2.2 | 15 | 12 |
| 10 (9.99) | 2.7 | 15 | 10.2 |
| 8 (8.13) | 2.2 | 10 | 10.4 |
| 6 (5.81) | 1.8 | 5.6 | 10.5 |
| 4 (3.81) | 1.2 | 2.2 | 12.9 |
| 2 (2.20) | 1.2 | 0.82 | 11.9 |

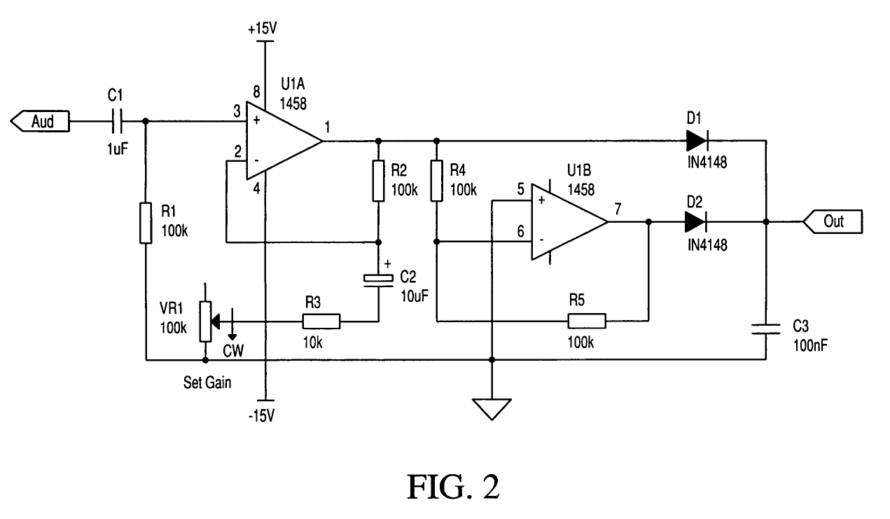

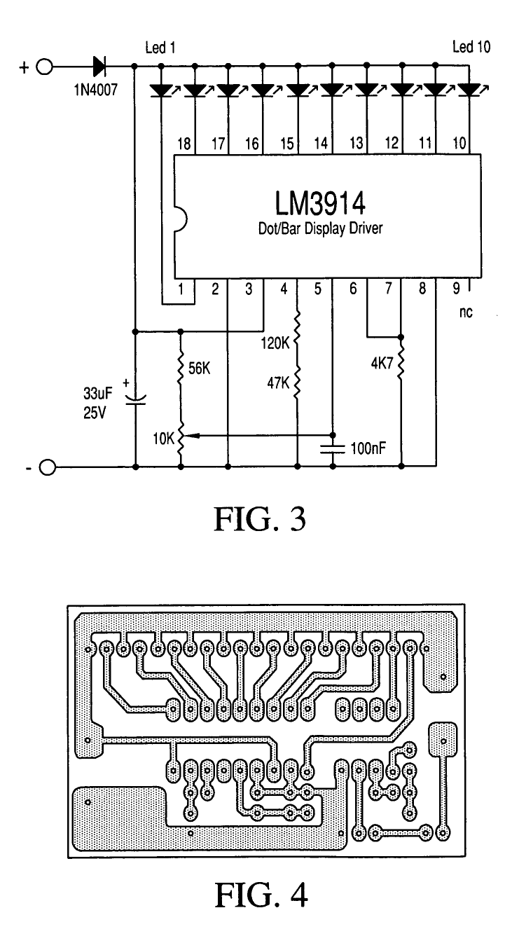

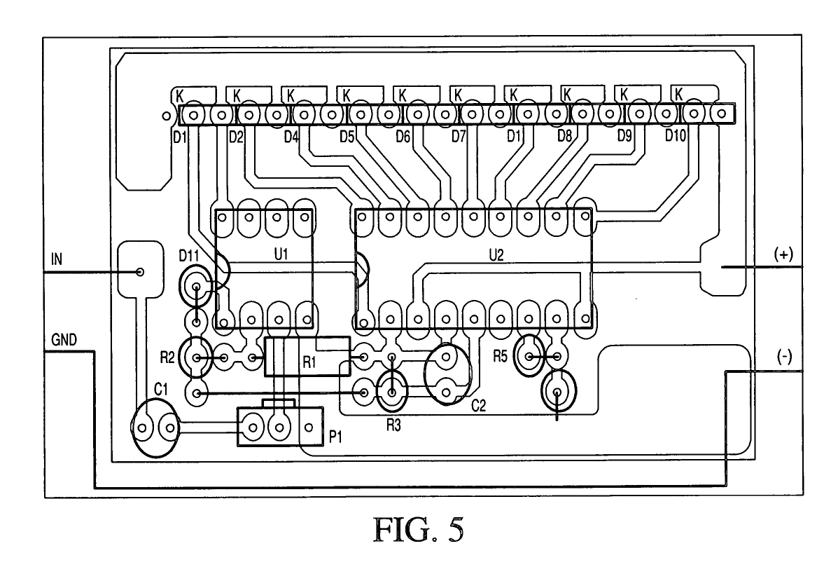

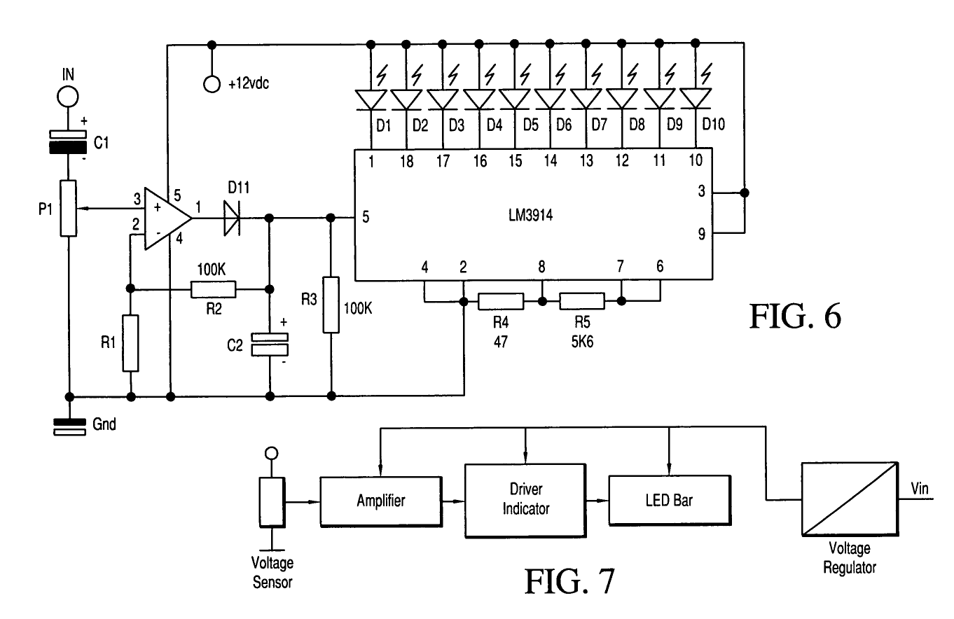

Now, if the above fails to meet the needs, one can download a little calculator that will do what is needed, and can even check what values you will get from “real world” resistor values. The circuit only senses the positive signal (i.e. it is half-wave only). In most cases this is not a problem, because although audio waveforms are asymmetrical, the overall signal usually balances out over a period of time. If this is not desirable, a simple rectifier circuit using a dual opamp (a cheap one is quite OK) is shown in FIG. 2, and can be added between the signal source and the input. This is not a “precision” rectifier, and as such will introduce a small error into the signal, causing the sensitivity of low level signals to be reduced. The lowest couple of LEDs will therefore not be exactly 3 dB apart, but for monitoring purposes this error can be completely ignored.

If a substitute fixed 100 k resistor for VR1 (from Pin 5 to ground) in FIG. 1, can be used to bring the signal into the IC via R1 as shown. VR1 in the signal rectifier will be used to change the gain rather than the meter circuit. R3 and R4 should use the values shown in FIG. 1 for best accuracy.

The signal rectifier needs a +/−supply of 15 volts, and the output is fed directly into the “Aud” input of the meter circuit. It is suggested that the signal level to the rectifier be reasonably high (or use the “Set Gain” control to increase the gain of the first stage). This will minimize the errors from a “less than perfect” rectifier. The reason for not using a precision rectifier circuit is simply one of cost. The speed of the circuit can be adjusted by varying the value of C3. With a high value (say 10 uF), the meter will act more like a peak programmed meter, holding the highest peaks for a relatively long time. The lower the value, the more quickly the meter will respond.

The gain of this circuit (as shown) is limited to a maximum of 11. At higher gain values, cheap opamps (such as the 1458) will be unable to amplify the highest frequencies due to their bandwidth limitations. This means that the lowest level signal you can have for a full scale reading will be about 1.3V peak, or about 900 mV RMS. The maximum gain I would recommend is obtained using a 4.7 k resistor for R3. This will give a gain of about 22, at which point the response will barely make it to 20 kHz. This equates to a maximum signal sensitivity of a little under 400 mV RMS. It is unlikely that this will ever be needed in practice, as it is far too low to operate any preamp or mixer and retain respectable noise performance.

You have (of course) selected the resistors R3 and R4 to give a reference voltage slightly lower than the peak voltage to be measured. Now the meter can be calibrated to suit your application.

This could not be simpler. At the maximum level to operate the equipment (as shown on an audio millivoltmeter or oscilloscope with signal applied), adjust VR1 so that the signal illuminates all the green LEDs (II is the most sensitive, and L10 indicates maximum level, so L1 to L8 should be lit). If the input is directly from a speaker output, an additional series resistor should be used at the “Aud” input terminal to reduce the level. This can be determined by calculation or by experiment. As a guide, for a SOW amplifier the external resistance should be about 47 k ohms.

If using the external signal rectifier, VR1 should have been omitted from the circuit as described above. Apply the signal voltage to the input of the signal rectifier at the maximum permitted level. Adjust VR1 (on the rectifier) to illuminate LEDs L1 to L8.

If calibrating the meter for a power amplifier, set the output to a level just below clipping. Adjust the level control until all LEDs are illuminated. This way, if the last LED (L10) lights when listening to music, you will know that you are very close to clipping, and the volume should be reduced.

This simple circuit makes it possible to monitor the charging process to a higher level. Final adjustments are simple and the only thing needed is a digital voltmeter for the necessary accuracy. Connect an input voltage of 12.65 volt between the positive and negative poles and adjust the 10K trimmer potentiometer until LED 10 lights up. Lower the voltage and in sequence all other LED's will light up. Check that LED 1 lights up at approximately 11.89 volts.

At 12.65 volt and higher the battery is fully charged, and at 11.89 is considered “empty”. The green LED's indicate that the battery capacity is more than 50%, the yellow LED's indicate a capacity of 30%-50% and the red LED's less that 30%. This circuit, with the components showed uses less than 10 mA. Of course, one can adapt this circuit to one's own needs by making small modifications. The circuits above is set for ‘DOT’ mode, meaning only one LED at a time will be lit. If you wish to use the ‘BAR’ mode, then connect pin 9 to ground, but obviously with increased current consumption. The LED brightness can be adjusted up or down by choosing a different value for the 4K7 resistor connected at pin 6/7. You can also change the to monitoring voltage level. For example, let's say you wanted to change to 10-13 volt, you connect 13 volt to the input (+ and −) and adjust the 10 K potentiometer until LED 10 lights up. Change temporarily the resistors at pin 4 with a 200 Kilo-ohm potentiometer and reconnect a voltage from 10 Volt to the input. Now, re-adjust the 200 K potentiometer until LED 1 lights up. When you are satisfied with the adjustment, you can exchange the 200K potentiometer with resistors again (after measuring the resistance from the pot, obviously). The diode IN4007 was included to protect the circuit from a wrong polarity connection.

It is however strongly recommended to connect the monitor directly to the battery, in principle a connection to the cigarette lighter would suffice but for reasons unknown at this time the voltage at that point is 0.2 volt lower than the voltage measured directly on the battery.

While the invention has been described in correction with its preferred embodiments, it should be recognized that changes and modifications may be made therein without departing from the scope of the appended claims.

What is claimed is:

1. A progressive brake light warning system for a motor vehicle comprising:
a variable brightness brake light in which the brightness of said light increases and with changes in voltage;
electrical circuit means and a pressure sensor for sensing the pressure applied to a brake pedal and increasing the voltage output of said electrical circuit means as the pressure increases and decreasing the voltage output as the pressure is decreased;
means for connecting the voltage output to the brake lamp;
means for flashing the brake light on and off when the pressure on the brake pedal exceeds a preselected level;
means for sensing forward movement of the auto; and
means for maintaining the flashing of the brake light until the vehicle resumes forward movement.
